(19) United States
(12) Patent Application Publication
(10) Pub. No.: US 2022/0253856 A1
(43) Pub. Date: Aug. 11, 2022

(54) SYSTEM AND METHOD FOR MACHINE LEARNING BASED DETECTION OF FRAUD

(71) Applicant: THE TORONTO-DOMINION BANK, Toronto (CA)

(72) Inventors: KEITONG WONG, MARKHAM (CA); LU ZOU, NORTH YORK (CA); YIFAN WANG, NORTH YORK (CA)

(21) Appl. No.: 17/173,798

(22) Filed: Feb. 11, 2021

(51) Int. Cl. G06Q 20/40; G06N 3/08; G06N 3/04; G06Q 30/00

(52) U.S. Cl. CPC G06Q 20/4016; G06N 3/088; G06Q 40/02; G06Q 30/0185; G06N 3/0454

(57) ABSTRACT

A computing device for fraud detection of transactions for an entity is disclosed, the computing device receiving a current customer data comprising a transaction request for the entity. The transaction request is analyzed using a trained machine learning model to determine a likelihood of fraud via determining a difference between values of an input vector of pre-defined features for the transaction request applied to the trained machine learning model and an output vector having corresponding features resulting from applying the input vector. The trained machine learning model is an unsupervised model trained with only positive samples of legitimate customer data having values for a plurality of input features corresponding to the pre-defined features for the transaction request and defining the legitimate customer data. The difference is used to automatically classify the current customer data as either fraudulent or legitimate based on a comparison of the difference to a pre-defined threshold.

### FIELD

The present disclosure relates to computer-implemented systems and methods that determine, in real time, a likelihood of a fraudulent transaction based on a trained machine learning model.

### BACKGROUND

For many institutions including the financial services industry, one of the key hurdles is dynamic and accurate detection of fraudulent interactions in order to be able to respond quickly. Such interactions can occur for example, when a customer engages an institution server via a website or a native application for requesting a new service, requesting payment transfer via a transaction or submitting a new customer application. As fraudsters are known to be constantly adapting their methods, a fraud detection algorithm which is based only on historical fraud data (e.g. for the last year) will be ineffective against a subsequent year's fraud tactics.

Additionally, fraudsters may occupy different percentage of the population in different years and dependent on the type of fraud. For example, in one year, less than 10% of accounts opened may be fraudulent. In other years, this may change. Based on the skewed population, the traditional threshold approach to fraud detection applied will lead to inaccuracies for its inability to accurately capture the online behaviour of fraudsters. Such overarching threshold algorithms which do not take into consideration characteristics of the population will not be generally applicable to a larger population and unable to provide accurate predictions.

Thus there exists a need to provide machine-learning systems and methods that dynamically analyze transaction data to detect fraudulent transactions and thereby fraudulent actions including requests for new customer applications.

### SUMMARY

Like reference numbers and designations in the various drawings indicate like elements.

In one aspect, there is provided a computing device for fraud detection of transactions associated with an entity, the computing device comprising a processor, a storage device and a communication device wherein each of the storage device and the communication device is coupled to the processor, the storage device storing instructions which when executed by the processor, configure the computing device to: receive at the computing device, a current customer data comprising a transaction request received at the entity; analyze the transaction request using a trained machine learning model to determine a likelihood of fraud via determining a difference between values of an input vector of pre-defined features for the transaction request applied to the trained machine learning model and an output vector having corresponding features resulting from applying the input vector, wherein the trained machine learning model is trained using an unsupervised model with only positive samples of legitimate customer data having values for a plurality of input features corresponding to the pre-defined features for the transaction request and defining the legitimate customer data; apply a pre-defined threshold to the difference for determining a likelihood of fraud, the threshold determined based on historical values for the difference when applying the trained machine learning model to other customer data obtained in a prior time period; and, automatically classify the current customer data as either fraudulent or legitimate based on a comparison of the difference to the pre-defined threshold.

In one aspect, the trained machine learning model is an auto-encoder model having a neural network comprising an input layer for receiving the input features of the positive sample and in a training phase, replicates output resulting from applying the input features to the auto encoder model by minimizing a loss function therebetween.

In one aspect, the pre-defined features comprise: identification information for each customer; corresponding online historical customer behaviour in interacting with the entity; and a digital fingerprint identifying the customer within the entity.

In one aspect, the trained machine learning model comprises at least three layers including an encoder for encoding the input vector into an encoded representation represented as a bottleneck layer; and a decoder layer for reconstructing the encoded representation back to an original reconstructed format representative of the input vector such that the bottleneck layer being a middle stage of the trained machine learning model has less number of features than a number of features in the input vector of pre-defined features.

In one aspect, classifying the current customer data, marks the current customer data as legitimate if the difference is below a pre-set threshold and otherwise as fraudulent.

In one aspect, the processor further configures the computing device to: in response to classification provided by the trained machine learning model, receive input indicating that the current customer data is incorrectly classified as fraudulent when legitimate or legitimate when fraudulent; and automatically re-train the model to include the current customer data as a further positive sample to generate an updated model.

In one aspect, the trained machine learning model is updated based on an automatic grid search of hyper parameters and k-fold cross validation to update model parameters thereby optimizing the loss function.

In another aspect, there is provided a computing device for training an unsupervised machine learning model for fraud detection associated with an entity, the computing device comprising a processor, a storage device and a communication device where each of the storage device and the communication device is coupled to the processor, the storage device storing instructions which when executed by the processor, configure the computing device to: receive one or more positive samples relating to legitimate customer data for the entity, wherein the legitimate customer data includes values for a plurality of input features characterizing the legitimate customer data; train, using the one or more positive samples, the unsupervised machine learning model for the legitimate customer data; optimize the unsupervised machine learning model by automatically tuning one or more hyper-parameters such that a difference between an input having the input features representing the legitimate customer data to the model and an output resulting from the model during the training is below a given threshold; and generate a trained model, from the optimizing, as an executable which when applied to current customer data for the entity is configured to automatically classify the current customer data as either fraudulent or legitimate.

In yet another aspect, there is provided a computer implemented method for training an unsupervised machine learning model for fraud detection associated with an entity, the method comprising: receiving one or more positive samples relating to legitimate customer data for the entity, wherein the legitimate customer data includes values for a plurality of input features characterizing the legitimate customer data; training, using the one or more positive samples, the unsupervised machine learning model for the legitimate customer data; optimizing the unsupervised machine learning model by automatically tuning one or more hyper-parameters such that a difference between an input having the input features representing the legitimate customer data to the model and an output resulting from the model during the training is below a given threshold; and generating a trained model, from the optimizing, as an executable which when applied to current customer data for the entity is configured to automatically classify the current customer data as either fraudulent or legitimate.

In one aspect, the hyper-parameters tuned comprise: a number of nodes per layer of the machine learning model; a number of layers for the machine learning model; and a loss function used to calculate the difference.

In one aspect, the machine learning model is an auto-encoder model having a neural network comprising an input layer for receiving the input features of the positive sample and replicates the output to the input features by minimizing the loss function providing an indication of a difference between an input vector and an output vector for legitimate data provided to the unsupervised machine learning model.

In one aspect, the input features comprise: identification information for each customer; corresponding historical customer behaviour in interacting with the entity; and a digital fingerprint identifying the customer within the entity.

In one aspect, the machine learning model comprises at least three layers including an encoder for encoding the input features into a encoded representation representing a bottleneck layer and a decoder layer for reconstructing the encoded representation back to an original format representative of the input features such that the bottleneck layer being a middle stage of the model has less number of features than a number of features in the input features.

In one aspect, the method further comprises: classifying the current customer data as legitimate if a difference between an input vector of features characterizing the current customer data provided as input to the model and corresponding output vector of features is below a pre-set threshold and otherwise as fraudulent.

In one aspect, in response to classification provided by the trained model, receiving input indicating that the current customer data is incorrectly classified as fraudulent when legitimate or legitimate when fraudulent; and automatically re-training the model to include the current customer data as a further positive sample to generate an updated model.

In one aspect, features defined in the input features are similar to corresponding features in the current customer data used to automatically classify the current customer data as fraudulent or legitimate.

In one aspect, optimizing the unsupervised machine learning model is performed based on an automatic grid search of hyper parameters and k-fold cross validation to update model parameters thereby optimizing the loss function providing an indication of a difference between an input vector and an output vector for legitimate data provided to the unsupervised machine learning model.

In yet another aspect, there is provided a computer implemented method for fraud detection of transactions associated with an entity, the method comprising: receiving at a computing device, a current customer data comprising a transaction request received at the entity; analyzing the transaction request using a trained machine learning model to determine a likelihood of fraud via determining a difference between values of an input vector of pre-defined features for the transaction request applied to the trained machine learning model and an output vector having corresponding features resulting from applying the input vector, wherein the trained machine learning model is trained using an unsupervised model with only positive samples of legitimate customer data having values for a plurality of input features corresponding to the pre-defined features for the transaction request and defining the legitimate customer data; applying a pre-defined threshold to the difference for determining a likelihood of fraud, the threshold determined based on historical values for the difference when applying the trained machine learning model to other customer data obtained in a prior time period; and, automatically classifying the current customer data as either fraudulent or legitimate based on a comparison of the difference to the pre-defined threshold.

In accordance with further aspects of the disclosure, there is provided an apparatus such as a computing device for processing data for detection of fraud in real-time using unsupervised machine learning models and positive samples for training the models, a method for adapting same, as well as articles of manufacture such as a computer readable medium or product and computer program product or software product (e.g., comprising a non-transitory medium) having program instructions recorded thereon for practicing the method(s) of the disclosure.

### BRIEF DESCRIPTION OF THE DRAWINGS

These and other features of the disclosure will become more apparent from the following description in which reference is made to the appended drawings wherein:

FIG. 1 is a block diagram illustrating an example computing device communicating in a communication network and configured to output a determination of a likelihood of fraud via trained machine learning models, in accordance one or more aspects of the present disclosure.

FIG. 2 is a block diagram illustrating further details of the example computing device of FIG. 1, in accordance one or more aspects of the present disclosure.

FIG. 3 is a block diagram illustrating further details of a fraud detection module of FIG. 1 and/or FIG. 2, in accordance one or more aspects of the present disclosure.

FIG. 4 is a block diagram illustrating further details of a trained machine learning model of FIG. 3, in accordance one or more aspects of the present disclosure.

FIGS. 5 and 6 are flowcharts illustrating example operations for the computing device of FIG. 1, in accordance with one or more examples of the present disclosure.

### DETAILED DESCRIPTION

One or more currently preferred embodiments have been described by way of example. It will be apparent to persons skilled in the art that a number of variations and modifications can be made without departing from the scope of the disclosure as defined in the claims.

While various embodiments of the disclosure are described below, the disclosure is not limited to these embodiments, and variations of these embodiments may well fall within the scope of the disclosure. Reference will now be made in detail to embodiments of the present disclosure, examples of which are illustrated in the accompanying drawings. Wherever possible, the same reference numbers will be used throughout the drawings to refer to the same or like parts.

Generally, the present disclosure relates to computer-implemented methods and systems, according to one or more embodiments, which among other steps, facilitates a flexible, dynamic and real-time analysis of customer data, such as transaction data from online interactions with an entity (e.g. one or more transaction servers of a financial institution), using an unsupervised trained machine learning model which has been trained on only legitimate data, that when processes the customer data determines a likelihood as to whether the customer data is legitimate or fraud, based on thresholds defined from historical customer data for the entity. In this way, customer data which is defined as fraud may be flagged, in real-time for subsequent review.

Conveniently, as the amount of online customer data including online interactions (e.g. requests for opening an account for a customer, requests for payment or transfers between accounts, requests for additional financial services, etc.) which flow through one or more servers associated with entity at any given time, can be quite large and the fraudulent activities are constantly changing, certain of the exemplary processes and systems, enable a real-time, computationally efficient and accurate detection of fraud customer transactions within all of the online customer data, via an unsupervised trained machine learning model which improves efficiency of detection via training the model using prior customer data that is known to be legitimate. Further conveniently, during an initial training and development period of the machine learning model, certain of the exemplary processes and systems may allow automatic additional optimization and validation of the machine learning model, via grid based k-fold cross validation techniques to fine tune the parameters of the model (e.g. number of layers of the models; number of input features; the types of input features) and thereby further improve the accuracy of detection of fraud in certain examples.

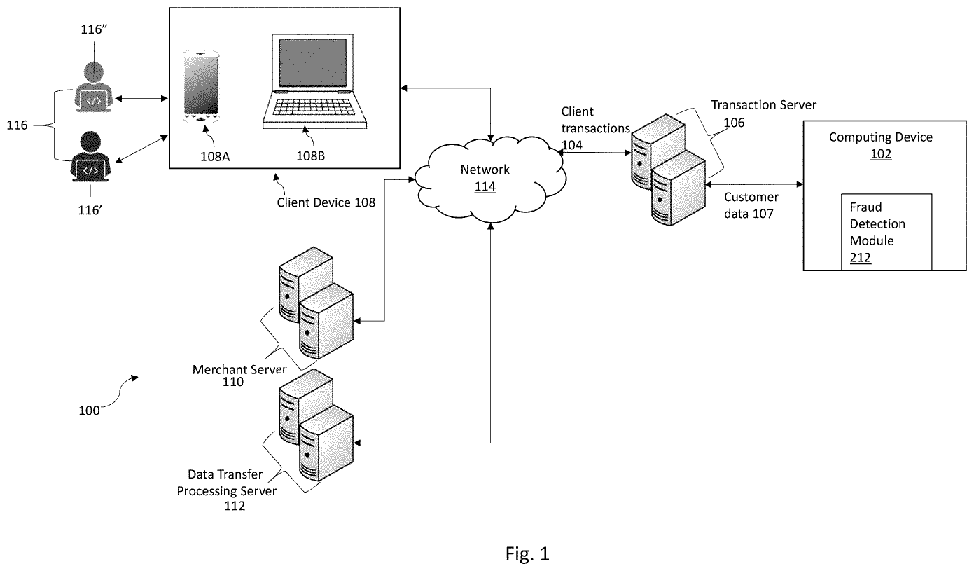

Referring to FIG. 1 shown is a diagram illustrating an example computer network 100 in which a computing device 102 is configured to communicate with one or more other computing devices, including a transaction server 106, one or more client devices 108 (example client devices shown individually shown as device 108A and 108b), a merchant server 110, and a data transfer processing server 112 using a communication network 114. Each of the transaction server 106, the merchant server 110, the data transfer processing server 112 and the client device 108 comprises at least one processor and one or more data stores, such as storage devices coupled thereto as well as one or more communication devices for performing the processes described herein. It is understood that this is a simplified illustration.

Client device 108 is configured to receive input from one or more users 116 (individually shown as example user 116″ and example user 116′) for transactions either directly with a transaction server 106 (e.g. a request to open a new account for users 116) or via a merchant server 110 (e.g. an online purchase made by users 116 processed by the merchant server 110) or via a data transfer processing server 112 (e.g. a request for transferring data either into or out of an account for users 116 held by transaction server 106).

Users 116 may be involved with fraudulent and/or legitimate financial activity. For example, in one scenario, user 116′ may initiate online fraudulent transactions with the transaction server 106 (e.g. server associated with a financial institution in which user 116′ transacts with) via the client device 108B and at the same time user 116″ may perform online legitimate transactions with the transaction server 106 via the client device 108A.

Data transfer processing device 112 processes data transfers between accounts held on transaction server 106 such as a source account (e.g. account held on transaction server 106 for user 116′) and a destination account (e.g. account for user 116″ held on transaction server 106). This can include for example, transfers of data between one source user account to a destination user account for the same user 116 or from a source account associated with one user to another user (e.g. where account information for users 116 may be held on the transaction server 106).

Merchant server 110 stores account information for one or more online merchants which may be accessed by user 116 via client device 108 for processing online transactions including purchases or refunds for an online item such as to effect a data transfer into an account for user 116 or out of an account for user 116 (e.g. where account information for users 116 and/or merchants may be further held in transaction server 106).

Transaction server 106 is configured to store account information for one or more users 116 and to receive one or more client transactions 104 either directly from the client device 108 or indirectly, these may include but not limited to: changes to user accounts associated with user 116, including data transfers, via merchant server 110 and/or data transfer processing server 112. The client transactions 104 can include customer account data for users 116 such as a query to open a new account, to add additional financial services to an existing account, requests for purchasing investments or other financial products, request for online purchases, requests for bill payments or other data transfers from a source account to a destination account, at least one of which associated with a user 116, or other types of transaction activity. The client transactions 104 may include information characterizing each particular transaction, such as a bill payment or a data transfer or a request to open an account. The additional information may include, device(s) used for requesting the transaction such as client device 108; accounts involved with the transaction; customer information provided by the user 116 in requesting the transaction including name, address, birthdate, social insurance number, and email addresses, etc.

The transaction server 106 which stores account information for one or more users 116 and/or processes requests from users 116 via the client device 108 for new accounts/services, is configured to process the client transactions 104 and attach any relevant customer information associated with accounts for the users 116. Thus the transaction server 106 is configured for sending customer data 107 which includes customer characterization information (e.g. customer names, accounts, email addresses, home address, devices used to access accounts, etc.) and associated client transactions 104 (e.g. request to open account, or data transfer between accounts) to the computing device 102.

The client transactions 104 may originate from the client device 108 receiving input from a particular user 116 on a native application on the device 108 (e.g. a financial management application) and/or navigating to website(s) associated with an entity for the transaction server 106. Alternatively, the client transactions 104 may originate from the client device 108 or merchant server 110 or data transfer processing server 112 communicating with the transaction server 106 and providing records of transactions for users 116 in relation to one or more accounts held on the transaction server 106.

The computing device 102, then processes the customer data 107 which includes one or more transaction requests held within client transactions 104, and determines via a fraud detection module 212, a likelihood of fraud associated with current customer data 107 based on using a trained unsupervised machine learning model.

In the example of FIG. 1, merchant server 110, data transfer processing server 112 and transaction server 106 are servers. Each of these is an example of a computing device having at least one processing device and memory storing instructions which when executed by the processing device configure the computing device to perform operations.

Computing device 102 is coupled for communication to communication networks 114 which may be a wide area network (WAN) such as the Internet. Communication networks 114 are coupled for communication with client devices 108. It is understood that communication networks 114 are simplified for illustrative purposes. Additional networks may also be coupled to the WAN or comprise communication networks 114 such as a wireless network and/or a local area network (LAN) between the WAN and computing device 102 or between the WAN and any of client device 108.

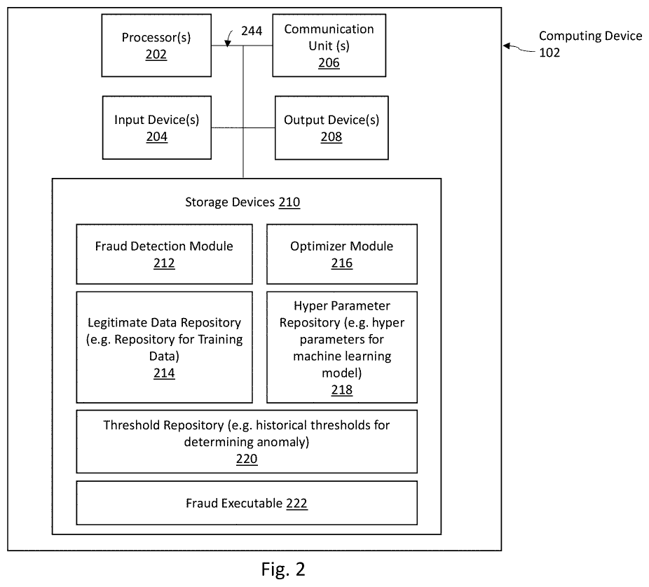

FIG. 2 is a diagram illustrating in block schematic form, an example computing device (e.g. computing device 102), in accordance with one or more aspects of the present disclosure, for example to provide a system and method to determine a likelihood of fraud in customer data (e.g. a transaction request) using a machine or artificial intelligence process that is unsupervised and preferably, trained using positive samples including only legitimate customer data (as opposed to customer data linked to fraud).

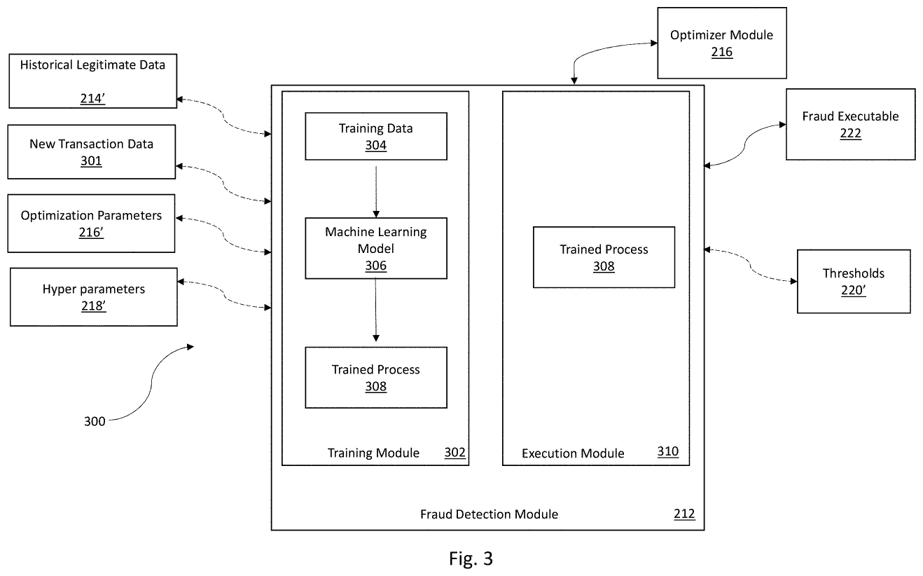

Computing device 102 comprises one or more processors 202, one or more input devices 204, one or more communication units 206 and one or more output devices 208. Computing device 102 also includes one or more storage devices 210 storing one or more modules such as fraud detection module 212, legitimate data repository 214 (e.g. storing historical customer data known to be legitimate such as historical legitimate data 214′ in FIG. 3); an optimizer module 216 (e.g. having optimization parameters 216′ shown in FIG. 3), a hyper parameter repository 218 (e.g. storing parameters for machine learning model in module 212 such as hyper parameters 218′ shown in FIG. 3); a threshold repository 220 (e.g. storing historical thresholds for anomaly detection during testing stage of machine learning model in module 212 such as pre-defined thresholds 220′ shown in FIG. 3); and a fraud executable 222.

Communication channels 244 may couple each of the components including processor(s) 202, input device(s) 204, communication unit(s) 206, output device(s) 208, storage device(s) 210 (and the modules contained therein) for inter-component communications, whether communicatively, physically and/or operatively. In some examples, communication channels 244 may include a system bus, a network connection, an inter-process communication data structure, or any other method for communicating data.

One or more processors 202 may implement functionality and/or execute instructions within computing device 102. For example, processors 202 may be configured to receive instructions and/or data from storage devices 210 to execute the functionality of the modules shown in FIG. 2, among others (e.g. operating system, applications, etc.). Computing device 102 may store data/information to storage devices 210. Some of the functionality is described further herein below.

One or more communication units 206 may communicate with external devices (e.g. client device(s) 108, merchant server 110, data transfer processing server 112 and transaction server 106) via one or more networks (e.g. communication network 114) by transmitting and/or receiving network signals on the one or more networks. The communication units 206 may include various antennae and/or network interface cards, etc. for wireless and/or wired communications.

Input devices 204 and output devices 208 may include any of one or more buttons, switches, pointing devices, cameras, a keyboard, a microphone, one or more sensors (e.g. biometric, etc.) a speaker, a bell, one or more lights, etc. One or more of same may be coupled via a universal serial bus (USB) or other communication channel (e.g. 244).

The one or more storage devices 210 may store instructions and/or data for processing during operation of computing device 102. The one or more storage devices 210 may take different forms and/or configurations, for example, as short-term memory or long-term memory. Storage devices 210 may be configured for short-term storage of information as volatile memory, which does not retain stored contents when power is removed. Volatile memory examples include random access memory (RAM), dynamic random access memory (DRAM), static random access memory (SRAM), etc. Storage devices 210, in some examples, also include one or more computer-readable storage media, for example, to store larger amounts of information than volatile memory and/or to store such information for long term, retaining information when power is removed. Non-volatile memory examples include magnetic hard discs, optical discs, floppy discs, flash memories, or forms of electrically programmable memory (EPROM) or electrically erasable and programmable (EEPROM) memory.

Fraud detection module 212 is configured to receive input from the transaction server 106 providing customer data 107 including transaction request information relating to users 116 holding account(s) on the transaction server 106 for the entity. The transaction information can include data characterizing types of transactions performed by one or more users 116 with regards to account(s) on the transaction server 106. Such transactions can include requests for opening a new account, request for data transfers between accounts (e.g. payment of a bill online between a source and a destination account), requests for additional services offered by the transaction server 106 (e.g. adding a service to an existing account), etc. Transaction information could also include additional identification information provided either by a user 116 in requesting a transaction including for example: geographical location of the user, email address of the user, user identification information such as date of birth, social insurance number, etc. The fraud detection module 212 is preferably configured to be running continuously and dynamically such as to digest current customer data 107 (including current transactions 104 providing transaction requests) on a real-time basis and utilize a trained unsupervised machine learning model to detect a likelihood of the presence of fraud.

Further, during an initial training period, the fraud detection module 212 accesses a legitimate data repository 214 to train the unsupervised machine learning model with legitimate data and improve prediction stability of the trained machine learning in later detecting fraud during execution. The legitimate data repository 214 contains training data with positive samples of legitimate customer data. For example, it may include values for a pre-defined set of features characterizing the legitimate customer data. The features held in the legitimate data repository 214 can include, identifying information about the corresponding legitimate customer (e.g. account(s) held by the legitimate customer; gender; address; location; salary; etc.); metadata characterizing online behaviour of the corresponding legitimate customer (e.g. online interactions between the users 116 and the transaction server such as interactions for opening accounts; modifying accounts; adding services; researching additional services; etc.). The fraud detection module 212 additionally accesses the hyper parameter repository which contains a set of hyper parameters (e.g. optimal number of layers; number of inputs to the model; number of outputs; etc.) for training the machine learning model.

The threshold repository 220 stores a set of historical thresholds used for optimally differentiating between fraud data and legitimate data in the customer data 107. The historical thresholds may be automatically determined for example, when testing the machine learning model of the fraud detection module 212, to automatically determine what threshold value (with respect to a difference between an input vector characterizing features of customer data input to the unsupervised machine learning model and an output vector recreated from the input vector) best separates fraud data and legitimate customer data.

Once the fraud detection module 212 having the machine learning model has been trained, tested and validated, the fraud executable 222 stores an output of the trained machine learning model as an executable which can then be accessed by the computing device 102 for processing subsequent customer data 107 (see FIG. 1).

The optimizer module 216 is configured to cooperate with the fraud detection module 212 such as to perform optimization and validation techniques on the machine learning models used including optimizing the hyper parameters defining the model and updating the hyper parameters in the repository 218 accordingly. The optimizer module 216 may for example utilize cross fold validation techniques with grid search of parameters to generate optimization parameters 216′ (see FIG. 3) to fine tune the hyper parameters (e.g. hyper parameters 218′).

Referring to FIG. 3, shown is an aspect of the fraud detection module 212 of FIG. 2. During the training stage, in at least one aspect, the fraud detection module 212 receives a set of historical legitimate data 214′ providing positive samples of legitimate customer data including values for a pre-defined set of input features characterizing the legitimate data. The fraud detection module 212 is configured to train a machine learning model 306 (e.g. an unsupervised auto encoder model) based on the historical legitimate data 214′, thereby improving predictability of fraud in the testing stage. The fraud detection module 212 is configured, in at least some embodiments, to be optimized during the testing stage by automatically adjusting one or more hyper parameters 218′ of the trained model such that a difference between an input with the input features and an output from the model is below a pre-defined acceptable threshold for the difference. Predicting whether fraud exists in customer data and online transactions performed by clients (e.g. new transaction data 301) is a challenge for financial institutions and typically manually estimated guesses of whether an interaction is fraudulent is typically performed manually, which can lead to significant inaccuracies as it is impossible to characterize accurately the large number of characteristics associated with each transaction.

In at least some aspects, the present computerized system and method streamlines the process to accurately and dynamically determine an existence of fraud in new transaction data 301 (e.g. current customer data including transaction information) in real-time by applying unsupervised machine learning models trained only using legitimate data as described herein for improved prediction stability.

Fraud detection module 212 performs two operations: training via training module 302 and execution for subsequent deployment via execution module 310.

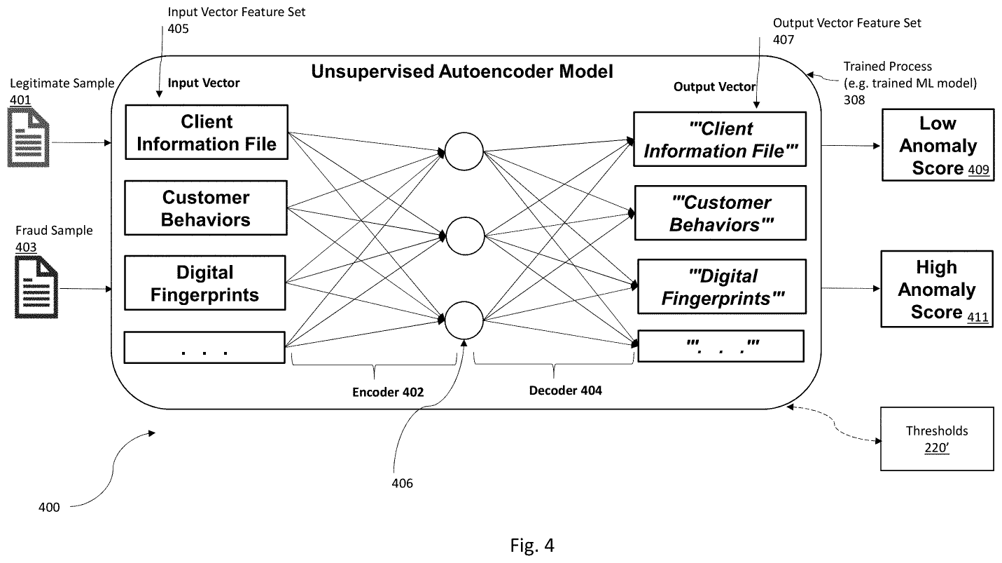

Training module 302 generates a trained process 308 for use by the execution module 310 to predict a likelihood of fraud in input new transaction data 301 (e.g. an example of customer data 107 shown in FIG. 1) and therefore classifies the transaction data 301 as fraudulent or legitimate. Training module 302 comprises training data 304 and machine learning algorithm 306. Training data 304 is a database of positive samples, e.g. historical customer data defined as legitimate and shown as historical legitimate data 214′. The historical legitimate data 214′ can include prior customer data including transaction requests known to be legitimate and feature set characterizing the legitimate data 214′. As shown in FIG. 4, which illustrates an example process 400 for applying the trained process 308 to detect fraud, an input vector feature set 405 applied to the trained process 308 can include a plurality of features such as client information; customer behaviors; and digital fingerprint for the user (e.g. user 116 in FIG. 1). These define an example feature set needed for both the training data 304 and in the testing/deployment stage for the new transaction data 301.

Machine learning model 306 may be a classification method, and preferably in accordance with one or more aspects, an unsupervised auto encoder model which attempts to find an optimal trained process 308. As illustrated in FIGS. 3 and 4, the unsupervised auto encoder model used as the machine learning model 306 includes an encoder 402 stage which maps the input vector feature set 405 to a reduced encoded representation as the encoded parameter set 406 (e.g. bottleneck layer) and a decoder stage 404 which attempts to recreate the original input feature set (e.g. the input vector feature set 405) by outputting an output vector feature set 407 having the same dimensionality of features as the input set. This training may include executing, by the training module 302, a machine learning model 306 to determine a set of model parameters based on the training set, including historical legitimate data 214′.

The trained process 308, utilizes one or more hyper parameters 218′ and automatically generates an optimal output vector feature set (e.g. output vector feature set 407) tracking the input vector feature set 405 to facilitate predicting likelihood of fraud in the input vector feature set 405 (e.g. new transaction data 301). Notably, on deployment, a pre-defined threshold 220′ may be applied to a difference between an input and output to the trained process 308, e.g. the feature sets 405 and 407, to dynamically analyze new transaction data 301 and predict a likelihood of fraud.

The pre-defined threshold 220′ may be defined for example, during a testing phase of the trained process 308 (e.g. see FIG. 4 example of a testing phase scenario whereby both legitimate sample 401 and fraud sample 403 are input into the trained process 308 using a trained unsupervised auto encoder machine learning model and the threshold 220′ is set such as to minimize the error between the input vector feature set 405 and the output vector feature set 407).

Referring again to FIGS. 3 and 4, in another aspect, the machine learning model 306 is preferably an unsupervised classification using an auto encoder.

Execution module 310 thus uses the trained process to 308 to generate a fraud executable 222 which facilitates finding an optimal relationship between a set of input features (e.g. feature set 405) and output decoded feature set (e.g. feature set 407) for prediction and classification of input information (e.g. new transaction data 301) as either fraudulent or legitimate.

The fraud detection module 212 may use one or more hyper parameters 218′ to tune the machine learning model generated in the trained process 308. A hyper parameter 218′ may include a structural parameter that controls execution of the machine learning model 306, such as a constraint applied to the machine learning model 306. Different from a model parameter, a hyper parameter 218′ is not learned from data input into the model. Example hyper parameters 218′ for the auto encoder machine learning model 306 include a number of features to evaluate (e.g. size of input vector feature set 405), a number of observations to use, a maximum size of the encoded representation as the encoded parameter set 406 (wherein the encoded parameter set preferably is smaller sized than the input vector feature set 405), a number of layers used in the encoder 402 and/or decoder 404. Preferably, the hyper parameters 218′ may be optimized via the optimizer module 216 (e.g. to general optimal model parameters based on testing stage including optimization parameters 216′) such as to minimize a difference between input and output to the model. In one aspect, the hyper parameters 218′, define that the unsupervised classification model applied by the machine learning model 306 is an auto encoder model. In one aspect, the initial set of hyper parameters 218′ may be defined via user interface and/or previously defined.

In at least some implementations, in response to classification provided by the trained machine learning model (e.g. trained process 308), the optimizer module 216 may provide a user interface to present results of the classification (e.g. low anomaly score 409 or high anomaly score 411 as discussed in FIG. 4). In response, the user interface may receive input on the computing device 102 indicating that the current customer data is incorrectly classified as fraudulent when legitimate or legitimate when fraudulent; and in response, the optimizer module 216 is configured to trigger modification of the hyper parameters (e.g. via optimization parameters 216′) such as to account for the input and automatically re-train the machine learning model 306 to include the current customer data as a further positive sample to generate an updated model.

In some implementations, the fraud detection module 212 may perform cross-validation and/or hyper parameter tuning when training machine learning model 306. Cross validation can be used to obtain a reliable estimate of machine learning model performance by testing a machine learning algorithm 306 ability to predict new data that was not used in estimating it. In some aspects, the fraud detection module 212 compares performance scores for each machine learning model, e.g. using a validation test set and may select the machine learning model with the best (e.g., highest accuracy, lowest error, or closest to a desired threshold) performance score as the trained process 308.

Preferably, in some implementations, the optimizer module 216 is further configured to validate the trained process 308 having an unsupervised auto encoder machine learning model using a set of tuning parameters including model structures and hyper parameters. Further, the cross validation preferably occurs using k-fold cross validation with grid search of all of the tuning parameters that is used to compare and determine which particular set of tuning parameters yields optimal performance of the machine learning model 306. In one example scenario, the machine learning model 306 includes two model parameters to tune (e.g. hyper parameters 218′) via the optimizer module 216, and possible candidates are parameter A: A1, A2 and parameter B: B1, B2. Based on a grid search, these would yield four possible combinations: (A1, B1), (A1, B2), (A2, B1), and (A2, B2). During the optimization stage, fraud detection module 212 provides each of these 4 combinations through a K-fold cross validation process (which concurrently performs training+validation) and produces an average performance metric (using the average L2 distance between the output and input as the performance metric) for each combination. Based on this, the optimizer module 216 determines which group of the parameters are the best to use, and there will be no further “validation” after that. Thus, the grid search and cross validation is performed automatically and the performance metric is used to compare the results and select the optimal tuning parameters (e.g. hyper parameters 218′).

Referring to FIG. 4 now in further detail, shown is a block diagram of a process 400 implemented by the fraud detection module 212 and depicting application of the trained process 308, whether in the testing or deployment stage, for detection of fraud in customer data 107 including transactions 104 (e.g. see FIG. 1). As shown in FIG. 4, the trained process 308 may receive any combination of legitimate sample 401 and/or fraud sample 403 being examples of types of information in new transaction data 301 (FIG. 3) or customer data 107 (FIG. 1). In either case, the trained process 308 uses an unsupervised auto encoder machine learning model which has been trained on legitimate data samples (e.g. 214′ shown in FIG. 3). Regardless of whether legitimate data sample 401 or fraud sample 403 is input, the characteristics are broken down into an input vector feature set. The input vector features set 405 to the trained process 308 has all of the raw features for characterizing the input data for fraud/legitimate classification and includes customer behaviour, customer info, and data fingerprints, etc. The trained process 308 of the machine learning model can include a number of middle layers. The machine learning model's goal is to replicate, during the training stage, the legitimate customer's data features and information (e.g. legitimate data 214′) with minimal errors. The output vector feature set 407 provided is a dimension of the original input vector, and every data point in the output vector has the same feature information as the input vector feature set 405. Referring again to FIG. 4, the process 400 calculates an error difference between the output vector feature set 407 and the input vector feature set 405. If the error difference exceeds a pre-defined threshold 220′ (e.g. as in the case of a fraud sample 403), then that is considered a high anomaly score 411 and classified as fraud whereby if the difference is below or equal to the threshold, the fraud detection module 212 considers it a low anomaly score 409 and thereby classifies the input information relating to a transaction (e.g. the legitimate sample 401) as legitimate.

Referring to FIGS. 3 and 4, the following summarizes example training, testing and deployment phases of the machine learning model 306, in accordance with one or more aspects of the disclosure. In the training stage, the machine learning model 306 receives training data 304, and encodes input features or variables of the training data 304 (e.g. the legitimate data 214′ samples). The machine learning algorithm starts with, by way of example, an input vector feature set (for the training data) being a 10 variable set and these are then mapped out and, through dimension reduction, mapped onto three variables during an encryption stage of the unsupervised auto encoder machine learning model (see encoded parameter set 406 as example of this in the testing stage). The machine learning model 306 then tries to decrypt the encryption made in order to replicate the input information. The machine learning model 306 automatically learns a way to encrypt as well as decrypt the information for optimal reproduction. As mentioned earlier, the training data 304 may include older customer information that is known to be legitimate data.

In the testing stage and as shown in FIG. 4, the anomaly score provided by the fraud detection module 212 of FIG. 3 calculates the difference between the two vectors (e.g. a distance between two vectors, input feature set 405 and output feature set 407) in order to predict whether fraud exists. If, for example, there are 10 variables in the input vector feature set 405, then they are projected into 10 dimensional spaces and the fraud detection module 212 measures the distance between the two vectors (e.g. 405 and 407).

In at least some implementations, the single measurement applied for calculating the difference is a Euclidean Distance (or L2 Distance) between the two vectors (e.g. input vector feature set 405 and output vector feature set 407), which is a single numeric value despite the shape of the vector.

During the testing phase of building the machine learning model, a threshold (e.g. pre-defined thresholds 220′) is selected to be used for distinguishing legitimate vs fraud transaction data 301. In use, if a particular transaction's (e.g. new transaction data 301) Euclidean Distance between input and rebuilt output vectors (e.g. 405 and 407) is above that threshold, the fraud detection module is configured to flag the transaction as being fraudulent.

Furthermore, in at least some implementations if the testing phase of the machine learning model 306 indicates that there is high anomaly scores (e.g. high difference between input vector of pre-defined features characterizing the transaction and output vector of corresponding features) even when the input data contains only legitimate customer information, then the optimizer module 216 will tune one or more layers of the neural network defining the model 306 and/or hyper-parameters 218′ such as regulation, etc., in order to optimize a machine learning model that produces a more satisfactory anomaly score performance.

In reference to FIGS. 3 and 4, in the testing phase of the trained process 308, and as shown in FIG. 4, both legitimate samples 401 and fraud samples 403 including fraudulent records are provided as input to the trained process 308. That is, although the training phase of the machine learning model 306 only involves the legitimate customer information (e.g. historical legitimate data 214′), but at the testing stage the fraud detection module 212 is configured to test the already trained and tuned (validated) model to see how it actually performs. If, in one example, while testing the trained process 308, the optimizer module 216 determines that low anomaly scores are achieved despite feeding in fraudulent information as an input for transactions (e.g. fraud sample 403), then the optimizer module 216 will revert to the tuning phase and tweak the machine learning model 306 parameters and retest the trained process 308 to ensure accurate classification of transactions.

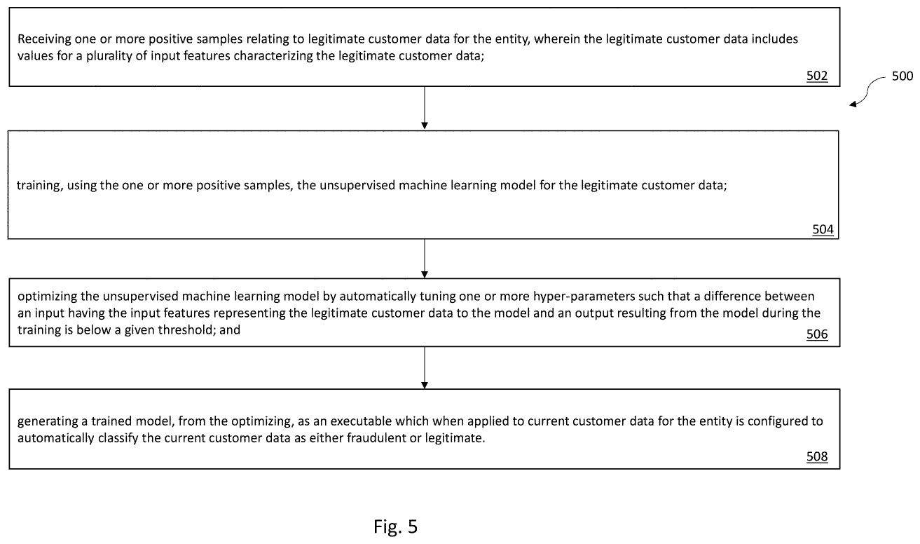

Referring to FIG. 5, shown is a flowchart of operations which may be performed by the computing device 102, in accordance with one or more embodiments. The computing device 102 as described herein, comprises at least one processor (e.g. processors 202 in FIG. 2) and a set of instructions, stored in a non-transient storage device (e.g. storage device 210 in FIG. 2), which when executed by the processor configure the computing device 102, and specifically the fraud detection module 212 of FIG. 2) to perform operations such as operations 500. The operations 500 facilitate training an unsupervised machine learning model (e.g. model 306 in FIG. 3) for fraud detection associated with an entity for subsequent detection of fraud in transactions between the entity and one or more client devices.

At 502, operations receive one or more positive sample relating to legitimate customer data (e.g. historical legitimate data 214′) for the entity, including a financial institution. The legitimate customer data includes values for a plurality of input features (e.g. client information, client customer behaviour, digital footprint, device information associated with transactions, etc.) characterizing the legitimate customer data.

At 504, the unsupervised machine learning model is trained using training data including only positive samples, e.g., the one or more positive samples of the legitimate customer data. For example, the legitimate customer data may be collected and tagged for a pre-defined past time period for subsequent use in the training phase.

Conveniently, by training the unsupervised machine learning such as to focus on legitimate customer's behaviour and information, the model is optimized to detect fraudulent transaction. For instance, when there is an input client transaction including transaction behaviour received at the computing device 102 which might be fraudulent, the computing device 102 will flag the behaviour as being out of the ordinary. Thus, in at least one instance, by training the unsupervised machine learning model using positive data, this create a large net to capture all of the outstanding bad or fraudulent data.

At 506, the unsupervised machine learning model is optimized (e.g. via the optimizer module 216) by automatically tuning one or more hyper parameters (e.g. hyper parameters 218′) such that a difference between an input having the input features representing the legitimate customer data to the model and an output resulting from the model during the training is below a given threshold (e.g. error in reconstruction is minimal). In one aspect, the optimization may include a grid search k-fold optimization of the hyper parameters. This may include for example, defining a set of possible hyper parameters and the grid search process attempts various combinations of hyper parameter values and ultimately selects the set of hyper parameter values which provide a most efficient and accurate unsupervised machine learning model (e.g. having the least amount of error between the input and output vector). Conveniently, this grid search optimization process discovers optimal hyper parameters (e.g. hyper parameters 218′) that work best on a legitimate customer data set. Additionally, in at least some aspects, optimization of the model may further include k-fold cross validation (which may be performed in parallel), whereby the testing data set is split into K subsets; a training data set including k−1 items is applied and a validation test data set of k items is applied; and the process is repeated until every subset has been used as a validation set in order to validate the performance of the unsupervised machine learning model and automatically adjust the hyper parameters where necessary. Assume, in one example, K=5 is used for the cross validation, then for the 4 combination of parameters discussed in the earlier example, (A1, B1), (A1, B2), (A2, B1), and (A2, B2), each would be trained and validated 5 times, to result in an average performance of each combination for comparison. In this example, 4-combination and 5-fold scenario would mean the machine learning model was trained and validated 20 times in total (4 models with different parameters, 5 times each).

At 508, a trained model is generated based on the training and optimization stage, as an executable (e.g. fraud executable 222) which when applied to current customer data (e.g. new transaction data 301) for the entity is configured to automatically classify the current customer data as either fraudulent or legitimate.

Specifically, the trained model when applied to current customer data, yields an output vector that is a reconstructed version (e.g. estimate of original format) of an input vector (e.g. see input vector feature set 405 and output vector feature set 407 in FIG. 4). The difference between the input and output vector may be calculated and if the difference exceeds a pre-defined threshold then the current customer data is considered fraudulent.

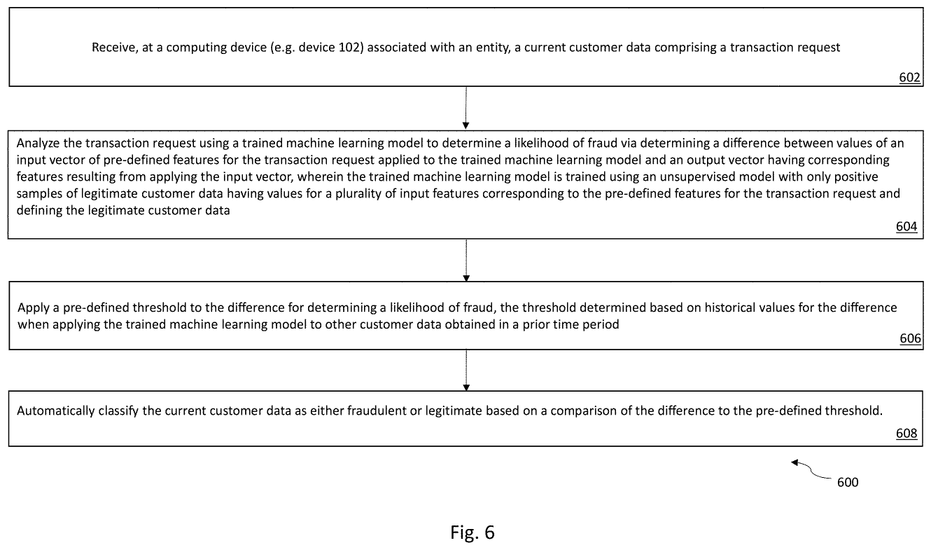

Referring now to FIG. 6 shown is a flowchart of example operations 600 performed by the computing device 102 for determining anomalies in current customer data and predicting a likelihood of fraud.

At 602, current customer data (e.g. customer data 107) including a transaction request (e.g. request to open a new account or add an additional services to an existing account) is received at a computing device associated with an entity (e.g. at computing device 102 via transaction server 106).

At 604, the transaction request (e.g. new transaction data 301 in FIG. 3) is analyzed using a trained machine learning model to determine a likelihood of fraud via determining a difference between an input vector, characterizing the transaction request, to the trained machine learning model and an output vector resulting therefrom. The difference is specifically calculated between values of an input vector of pre-defined features for the transaction request (e.g. input vector feature set 405) being applied to the trained machine learning model and an output vector having corresponding features resulting from applying the input vector. Notably, the trained machine learning model (e.g. trained process 308) is trained using an unsupervised model with only positive samples of legitimate customer data for training (e.g. historical legitimate data 214′) having values for a plurality of input features corresponding to the pre-defined features for the transaction request and defining the legitimate customer data. Simply put, the dimensionality of the feature vector set of the legitimate customer data used for training matches that of the current customer data 107 being tested.

In one example, the difference is Euclidean Distance (or L2 Distance) between the two vectors, which is a single numeric value despite the shape of the vector.

At 606, a pre-defined threshold (e.g. threshold 220′) is applied by the computing device 102 to the difference for determining a likelihood of fraud, the threshold being determined based on historical values for the difference when applying the trained machine learning model to other customer data obtained in a prior time period.

At 608, operations automatically classify the current customer data as either fraudulent (e.g. if the difference exceeds the threshold) or legitimate (e.g. if the difference is below the threshold) based on a comparison of the difference to the pre-defined threshold. During testing phase a threshold is selected to be used for distinguishing legit vs fraud, this threshold is defined to be optimal for distinguishing between fraud and legitimate transaction data based on prior transaction history. Thus, in use, if a current transaction defined in the current customer data has a Euclidean distance between input and rebuilt output vectors that is above that threshold, the transaction is predicted as being fraudulent.

Conveniently, referring to FIGS. 1-6, the trained machine learning model can detect fraud by using an unsupervised model which is able to compress and rebuild legitimate transactions during a training phase (together with all its features) effectively so that when a subsequent transaction input including a fraudulent transaction is fed into computing device 102 (e.g. and specifically the trained process 308 of the fraud detection module 212 shown in FIG. 3), the process 308 would have difficulty reconstructing it well, thus resulting in a large difference/distance (e.g. would be classified as fraudulent data in step 608).

Further conveniently, by only including legitimate data for transactions and not including fraud data in the training data set (e.g. training data 304), the machine learning model 306 fails to learn how to rebuild the fraud transactions accurately in the auto encoder model, therefore ensuring that when a fraud transaction is encountered in the testing phase, the later comparison of difference between the input and output vectors (e.g. 405 and 407) from reconstruction may be very distinguishable and indicative, therefore reducing computer resources utilized and improving accuracy of fraud detection.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit.

Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium. By way of example, and not limitation, such computer-readable storage media can comprise RAM, ROM, EEPROM, optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using wired or wireless technologies, such are included in the definition of medium. It should be understood, however, that computer-readable storage media and data storage media do not include connections, carrier waves, signals, or other transient media, but are instead directed to non-transient, tangible storage media.

Instructions may be executed by one or more processors, such as one or more general purpose microprocessors, application specific integrated circuits (ASICs), field programmable logic arrays (FPGAs), digital signal processors (DSPs), or other similar integrated or discrete logic circuitry. The term “processor,” as used herein may refer to any of the foregoing examples or any other suitable structure to implement the described techniques. In addition, in some aspects, the functionality described may be provided within dedicated software modules and/or hardware. Also, the techniques could be fully implemented in one or more circuits or logic elements. The techniques of this disclosure may be implemented in a wide variety of devices or apparatuses, an integrated circuit (IC) or a set of ICs (e.g., a chip set).

While operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

One or more currently preferred embodiments have been described by way of example. It will be apparent to persons skilled in the art that a number of variations and modifications can be made without departing from the scope of the disclosure as defined in the claims.

1. A computing device for fraud detection of transactions associated with an entity, the computing device comprising a processor, a storage device and a communication device wherein each of the storage device and the communication device is coupled to the processor, the storage device storing instructions which when executed by the processor, configure the computing device to:
receive at the computing device, a current customer data comprising a transaction request received at the entity;
analyze the transaction request using a trained machine learning model to determine a likelihood of fraud via determining a difference between values of an input vector of pre-defined features for the transaction request applied to the trained machine learning model and an output vector having corresponding features resulting from applying the input vector, wherein the trained machine learning model is trained using an unsupervised model with only positive samples of legitimate customer data having values for a plurality of input features corresponding to the pre-defined features for the transaction request and defining the legitimate customer data;
apply a pre-defined threshold to the difference for determining a likelihood of fraud, the threshold determined based on historical values for the difference when applying the trained machine learning model to other customer data obtained in a prior time period; and,
automatically classify the current customer data as either fraudulent or legitimate based on a comparison of the difference to the pre-defined threshold.

2. The computing device of claim 1, wherein the trained machine learning model is an auto-encoder model having a neural network comprising an input layer for receiving the input features of the positive sample and in a training phase, replicates output resulting from applying the input features to the auto encoder model by minimizing a loss function therebetween.

3. The computing device of claim 2, wherein the pre-defined features comprise: identification information for each customer; corresponding online historical customer behaviour in interacting with the entity; and a digital fingerprint identifying the customer within the entity.

4. The computing device of claim 3, wherein the trained machine learning model comprises at least three layers including an encoder for encoding the input vector into an encoded representation represented as a bottleneck layer; and a decoder layer for reconstructing the encoded representation back to an original reconstructed format representative of the input vector such that the bottleneck layer being a middle stage of the trained machine learning model has less number of features than a number of features in the input vector of pre-defined features.

5. The computing device of claim 4 wherein classifying the current customer data, marks the current customer data as legitimate if the difference is below a pre-set threshold and otherwise as fraudulent.

6. The computing device of claim 5 wherein the processor further configures the computing device to:
in response to classification provided by the trained machine learning model, receive input indicating that the current customer data is incorrectly classified as fraudulent when legitimate or legitimate when fraudulent; and
automatically re-train the model to include the current customer data as a further positive sample to generate an updated model.

7. The computing device of claim 2, wherein the trained machine learning model is updated based on an automatic grid search of hyper parameters and k-fold cross validation to update model parameters thereby optimizing the loss function.

8. (canceled)

9. (canceled)

10. (canceled)

11. (canceled)

12. (canceled)

13. (canceled)

14. (canceled)

15. (canceled)

16. (canceled)

17. (canceled)

18. A computer implemented method for fraud detection of transactions associated with an entity, the method comprising:
receiving at a computing device, a current customer data comprising a transaction request received at the entity;
analyzing the transaction request using a trained machine learning model to determine a likelihood of fraud via determining a difference between values of an input vector of pre-defined features for the transaction request applied to the trained machine learning model and an output vector having corresponding features resulting from applying the input vector, wherein the trained machine learning model is trained using an unsupervised model with only positive samples of legitimate customer data having values for a plurality of input features corresponding to the pre-defined features for the transaction request and defining the legitimate customer data;
applying a pre-defined threshold to the difference for determining a likelihood of fraud, the threshold determined based on historical values for the difference when applying the trained machine learning model to other customer data obtained in a prior time period; and,
automatically classifying the current customer data as either fraudulent or legitimate based on a comparison of the difference to the pre-defined threshold.

19. The method of claim 18, wherein the trained machine learning model is an auto-encoder model having a neural network comprising an input layer for receiving the input features of the positive sample and in a training phase, replicates output resulting from applying the input features to the auto encoder model by minimizing a loss function therebetween.

20. The method of claim 19, wherein the pre-defined features comprise: identification information for each customer; corresponding online historical customer behaviour in interacting with the entity; and a digital fingerprint identifying the customer within the entity.

21. The method of claim 20, wherein the trained machine learning model comprises at least three layers including an encoder for encoding the input vector into an encoded representation represented as a bottleneck layer; and a decoder layer for reconstructing the encoded representation back to an original reconstructed format representative of the input vector such that the bottleneck layer being a middle stage of the model has less number of features than a number of features in the input vector of pre-defined features.

22. The method of claim 21 wherein classifying the current customer data, marks the current customer data as legitimate if the difference is below a pre-set threshold and otherwise as fraudulent.

23. The method of claim 22 further comprising:
in response to classification provided by the trained machine learning model, receive input indicating that the current customer data is incorrectly classified as fraudulent when legitimate or legitimate when fraudulent; and
automatically re-train the model to include the current customer data as a further positive sample to generate an updated model.

24. The method of claim 19, wherein the trained machine learning model is updated based on an automatic grid search of hyper parameters and k-fold cross validation to update model parameters thereby optimizing the loss function.
